(19) United States
(12) Patent Application Publication
(10) Pub. No.: US 2011/0048246 A1
(43) Pub. Date: Mar. 3, 2011

(54) INNER POT ASSEMBLY FOR HOT-AIR BAKING OVEN AND HOT-AIR BAKING OVEN HAVING SUCH ASSEMBLY

(76) Inventor: Kuei-Tang CHANG, Banchiau City (TW)

(21) Appl. No.: 12/548,817

(22) Filed: Aug. 27, 2009

(51) Int. Cl. A21B 3/00

(52) U.S. Cl. 99/348

(57) ABSTRACT

An inner pot assembly for a hot-air baking oven includes a container body, a rotatable sleeve, a driven shaft, a speed-reducing mechanism and a stirring member. The bottom of the container body has a shaft mount. The rotatable sleeve penetrates the shaft mount to be rotatable with respect to the shaft mount. The driven shaft penetrates the rotatable sleeve to be rotatable with respect to the rotatable sleeve. The speed-reducing mechanism is fixed to the container body and has a speed-reducing gear set driven by the driven shaft and driving the rotatable sleeve to rotate. The stirring member is connected to the rotatable sleeve and received in the container body. The stirring member is driven by the rotatable sleeve. The speed-reducing mechanism drives the stirring member to stir the food items received in the container body, so that the food items can be baked uniformly.

### BACKGROUND OF THE INVENTION

1. Field of the Invention

The present invention relates to a hot-air baking oven, and in particular to an inner pot assembly for a hot-air baking oven.

2. Description of Prior Art

With the advancement of technology, various kinds of electrical appliances are used in a house to promote the domestic life. In addition to a microwave oven and a toaster, a hot-air baking oven is developed, which includes a pot, a cover and an electric heating module. The interior of the pot is formed into a cooking chamber for receiving food items. The cover is usually made of glass through which a user can observe the cooking condition of the food items received in the pot. The electric heating module generates high-temperature airflow and blows it into the pot. By means of the convection of the high-temperature airflow, the food items can be baked.

However, in practice, such a hot-air baking oven still has some problems. When the user intends to bake a number of small-sized food items (such as potato strips) in this hot-air baking oven, only the outer part of the potato strips are completely baked by the high-temperature airflow, but the inner part of the potato strips are not baked sufficiently because they are blocked by the outer part of the potato strips so as to unable to contact the high-temperature airflow sufficiently. In order to solve this problem, the user has to stir the potato strips periodically to make all of the potato strips to be baked uniformly. However, it is inconvenient for the user to stir the food items periodically, and thus the range of the food items to which the aforesaid hot-air baking oven can be applied is restricted.

Therefore, it is an important issue for the present Inventor to solve the above-mentioned problems.

### SUMMARY OF THE INVENTION

The present invention is to provide an inner pot assembly for a hot-air baking oven and a hot-air baking oven having such an assembly. A speed-reducing mechanism is provided in the inner pot assembly to drive a stirring member to stir the food items received in the hot-air baking oven, thereby making all the food items to be baked completely.

The present invention is to provide an inner pot assembly for a hot-air baking oven, which includes a container body, a rotatable sleeve, a driven shaft, a speed-reducing mechanism and a stirring member. The bottom of the container body has a shaft mount. The rotatable sleeve penetrates the shaft mount to be rotatable with respect to the shaft mount. The driven shaft penetrates the rotatable sleeve to be rotatable with respect to the rotatable sleeve. The speed-reducing mechanism is fixed to the container body and has a speed-reducing gear set driven by the driven shaft and driving the rotatable sleeve to rotate. The stirring member is connected to the rotatable sleeve and received in the container body. The stirring member is driven by the rotatable sleeve.

The present invention is to provide an inner pot assembly for a hot-air baking oven, which includes a container body, a rotatable mechanism, a speed-reducing mechanism and a stirring member. The bottom of the container body has a shaft mount. The rotatable mechanism penetrates the shaft mount to be rotatable with respect to the shaft mount. The speed-reducing mechanism is fixed to the container body and has a speed-reducing gear set in mutual transmission with the rotatable mechanism. The stirring member is connected to the rotatable mechanism and received in the container body. The stirring member is driven by the rotatable sleeve.

The present invention is to provide a hot-air baking oven having an inner pot assembly, which includes an outer pot, a heating device and an inner pot assembly. The outer pot is formed with a chamber. The heating device has a cover plate covering the outer pot and a motor mounted over the cover plate. The motor has a driving spindle. The inner pot assembly is received in the chamber and includes a container body, a rotatable sleeve, a driven shaft, a speed-reducing mechanism and a stirring member. The bottom of the container body has a shaft mount. The rotatable sleeve penetrates the shaft mount to be rotatable with respect to the shaft mount. The driven shaft penetrates the rotatable sleeve to be rotatable with respect to the rotatable sleeve. The speed-reducing mechanism is fixed to the container body and has a speed-reducing gear set driven by the driven shaft and driving the rotatable sleeve to rotate. The stirring member is connected to the rotatable sleeve and received in the container body. The stirring member is driven by the rotatable sleeve.

In comparison with prior art, the present invention has advantageous features as follows:

Since the inner pot assembly of the present invention is provided with the driven shaft, the speed-reducing mechanism and the stirring member, and the driven shaft is driven by the driving spindle of the motor of the heating device, it is not necessary to provide an additional motor to drive the driven shaft. Further, the speed-reducing mechanism drives the rotatable sleeve at low speed to rotate, and the rotatable sleeve drives the stirring member to stir the food items received in the inner pot assembly, so that the food items can be baked uniformly.

Since the inner pot assembly of the present invention is detachably connected between the heating device and the outer pot of the hot-air baking oven, the inner pot assembly is needed only when the user intends to bake a plurality of small-sized food items such as potato strips. In other words, when the inner pot assembly is not used, the outer pot and the heating device of the hot-air baking oven can still cooperate to bake a large-size food item. Thus, the hot-air baking oven having an inner pot assembly according to the present invention can bake a large range of food items, which increases the practicability of the hot-air baking oven.

### BRIEF DESCRIPTION OF THE DRAWINGS

FIG. 1 is a perspective view showing the external appearance of the inner pot assembly of the present invention;

FIG. 2 is a cross-sectional view showing the inner pot assembly of the present invention;

FIG. 3 is an exploded cross-sectional view showing the hot-air baking oven of the present invention.

FIG. 4 is an exploded view showing the driving spindle, the coupler and the driven shaft of the present invention;

FIG. 5 is an assembled cross-sectional view showing the inner pot assembly, the coupler and the driving spindle;

FIG. 6 is an assembled cross-sectional view showing the hot-air baking oven of the present invention;

FIG. 7 is an assembled cross-sectional view showing the operating state of the hot-air baking oven of the present invention; and

FIG. 8 is an exploded view showing another embodiment of the driving spindle and the driven shaft of the present invention.

### DETAILED DESCRIPTION OF THE INVENTION

The characteristics and technical contents of the present invention will be explained with reference to the accompanying drawings. However, the drawings are illustrative only but not used to limit the present invention.

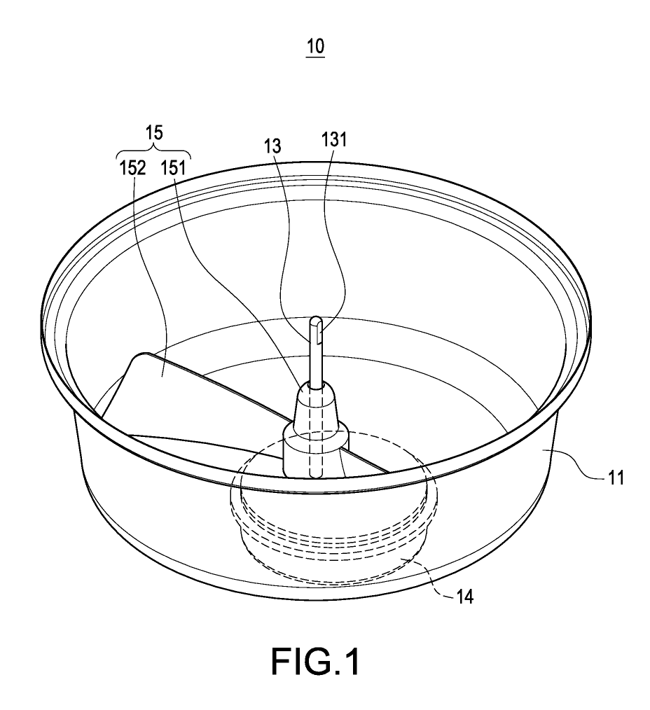

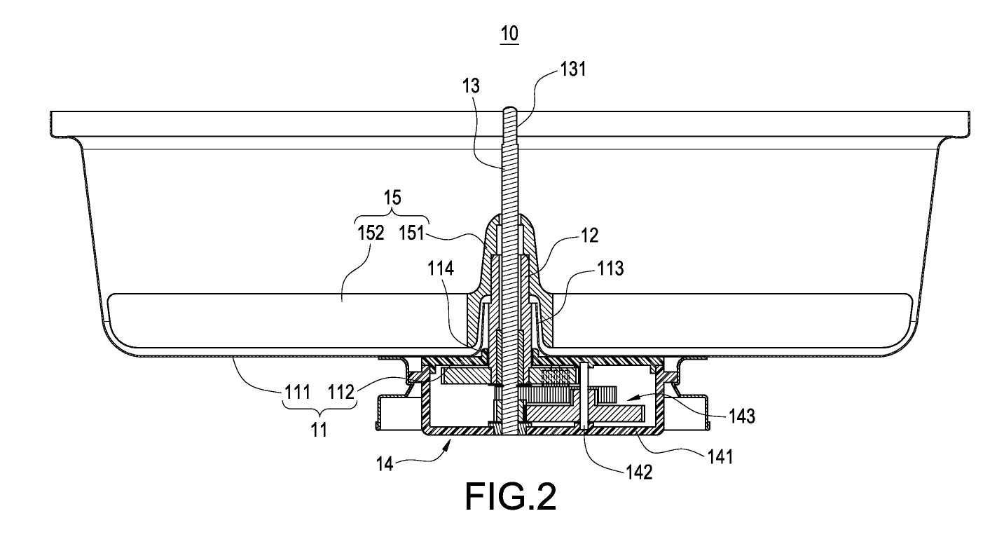

Please refer to FIGS. 1 and 2. The present invention provides an inner pot assembly for a hot-air baking oven. The inner pot assembly 10 includes a container body 11, a rotatable sleeve 12, a driven shaft 13, a speed-reducing mechanism 14 and a stirring member 15.

In the present embodiment, the container body 11 is formed of a cylinder 111 having a closed end and a base plate 112 fixed to the bottom surface of the cylinder 111. The center of the bottom of the cylinder 111 is formed into a hollow post 113. Further, the base plate 112 is formed with a shaft mount 114 at a position corresponding to that of the hollow post 113.

The rotatable sleeve 12 has a stepped profile, and it penetrates the hollow post 113 to be pivotally connected with the shaft mount 114 and rotatable with respect to the shaft mount 1 14.

The driven shaft 13 is an elongate rod, which penetrates the rotatable sleeve 12 to be rotatable with respect to the rotatable sleeve 12. A free end of the driven shaft 13 protruding outside the rotatable sleeve 12 is formed with a positioning plane 131. Alternatively, the rotatable sleeve 12 and the driven shaft 13 in the present embodiment can be assembled together to form a rotatable mechanism.

The speed-reducing mechanism 14 comprises a casing 141, two pivots 142 and a speed-reducing gear set 143. The casing 141 is used to seal the base plate 112 and allows the bottom end of the driven shaft 13 to be supported therein. Both ends of each pivot 142 are pivotally connected to the casing 141 and the base plate 112. The speed-reducing gear set 143 is constituted of a plurality of gears and idle wheels with different diameters. One of the gears is fixed to the bottom end of the driven shaft 13, and the other gear is fixed to the rotatable sleeve 12. The intermediate idle wheels are connected to the pivots 142 respectively. With the gear speed ratios among the gears and the idle wheels, the speed-reducing mechanism 14 can reduce the speed ratio between the driven shaft 13 and the rotatable sleeve 12.

The stirring member 15 is constituted of a central base 151 and a plurality of blades 152 extending outwards from the central base 151. The central base 151 is fixedly connected to the rotatable sleeve 12, so that the stirring member 15 can be driven by the rotatable sleeve 12 and rotatable therewith.

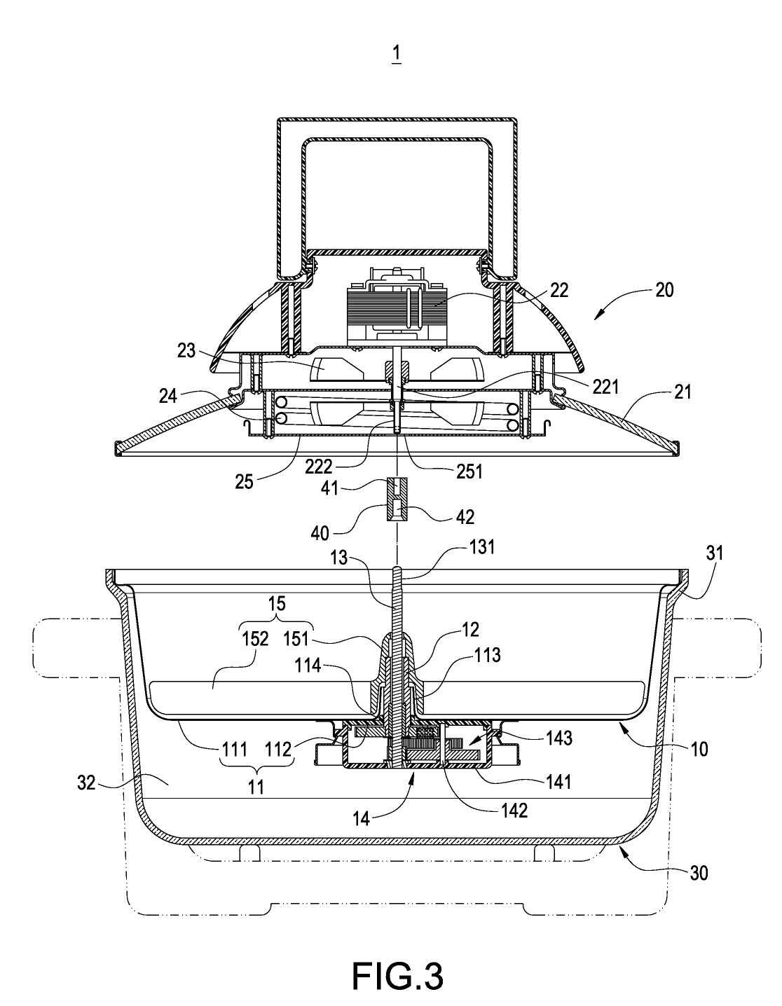

Please refer to FIG. 3. The present invention further provides a hot-air baking oven having an inner pot assembly. The hot-air baking oven 1 includes an inner pot assembly 10, a heating device 20 and an outer pot 30.

In the present embodiment, the heating device 20 is an electric heating device for generating hot airflow, which includes a cover plate 21, a motor 22, two impellers 23, an electric heating tube 24 and a protection plate 25. The cover plate 21 covers above the cylinder 111 of the inner pot assembly 10. The motor 22 is mounted to the center of the cover plate 21. The center of the motor 22 extends to have a driving spindle 221. The distal end of the driving spindle 221 is formed with an outer thread 222. The two impellers 23 are separated from each other in the vertical direction and are fixed to the middle section of the driving spindle 221 respectively. The electric heating tube 24 is fixed to the cover plate 21 to surround the lower impeller 23. The protection plate 25 is fixed inside the cover plate 21 at a position corresponding to the lower impeller 23 and the electric heating tube 24. The protection plate 25 is provided with a through-hole 251 for allowing the driving spindle 221 to penetrate there through. Further, the protection plate 25 is provided with a plurality of venting holes (not shown) at the area excluding the through-hole 251.

The outer pot 30 is also a cylinder having a closed end. The rim of the outer pot 30 is formed with a flange 31 for supporting the cylinder 111 of the container body 11. The interior of the outer pot 30 is formed with a chamber 32 for allowing the inner pot assembly 10 to be disposed therein.

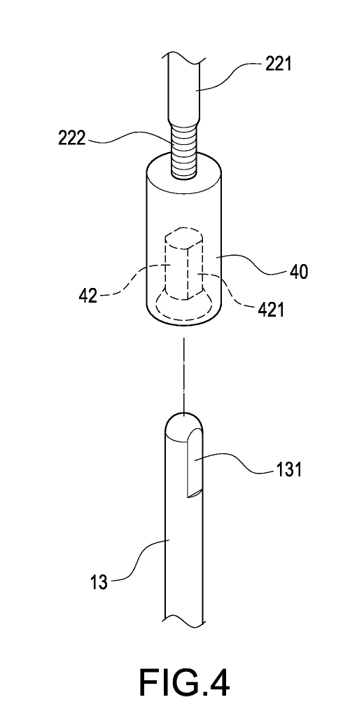

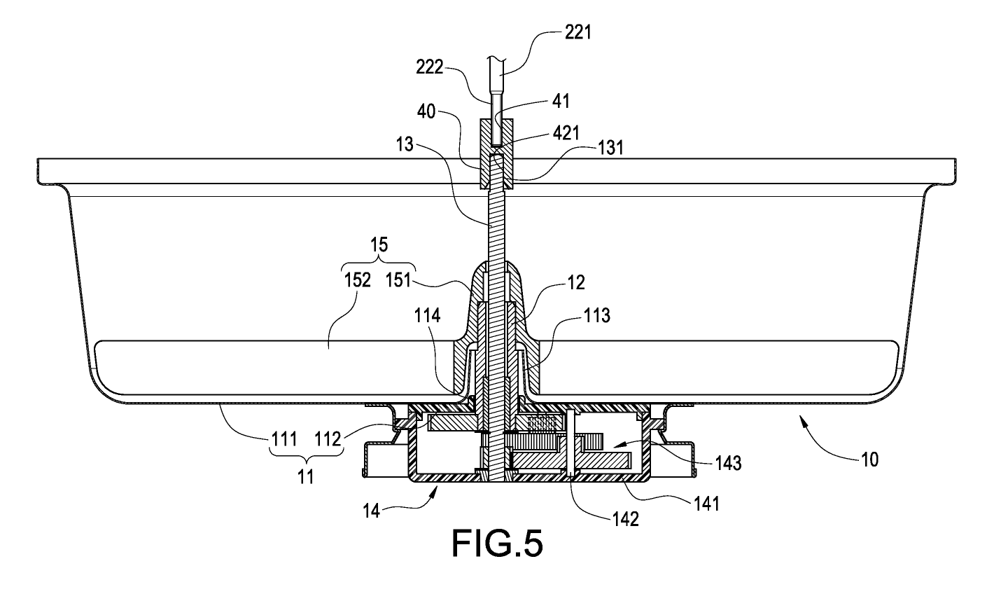

Please refer to FIGS. 4 and 5. The hot-air baking oven 1 further includes a coupler 40. The upper portion of the coupler 40 is provided with an inner thread 41 for threadedly connecting with the outer thread 222 of the driving spindle 221. The lower portion of the coupler 40 is provided with an insertion hole 42 for allowing the driven shaft 13 to be inserted therein. The inner wall of the insertion hole 42 is formed with a restricting plane 421 for mating with the positioning plane 131 of the driven shaft 13. With the arrangement, the driven shaft 13 can be driven by the coupler 40 to rotate therewith.

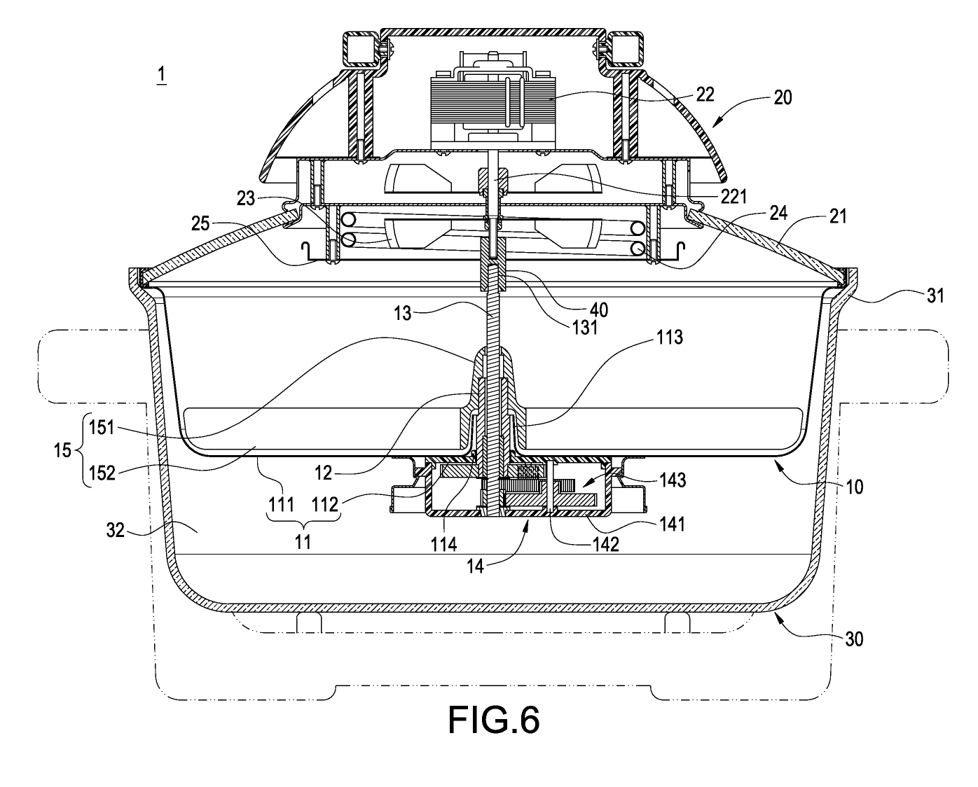

Please refer to FIG. 6. When in use, the coupler 40 first penetrates the through-hole 251 of the protection plate 25 with the inner thread 41 of the coupler 40 being threadedly connected with the outer thread 222 of the driving spindle 221. Next, the inner pot assembly 10 is disposed in the chamber 32 of the outer pot 30, and the inner pot assembly 10 is supported by the flange 31 of the outer pot 30 at a proper height. Then, the cover plate 21 of the heating device 20 covers the container body 11 of the inner pot assembly 10 in such a manner that the insertion hole 42 of the coupler 40 is inserted by the driven shaft 13 and the positioning plane 131 of the driven shaft 13 mates with the restricting plane 421 of the insertion hole 42. In this way, the hot-air baking oven 1 can be assembled together.

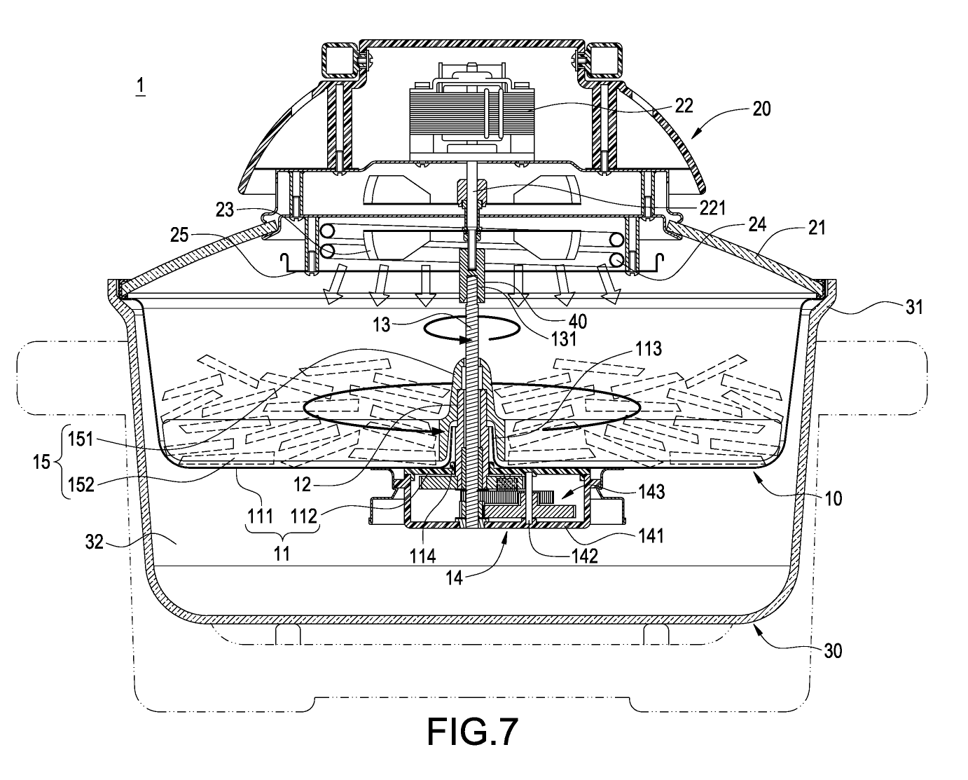

Please refer to FIG. 7. When in use, the food items to be baked (such as potato strips) are put into the cylinder 111 of the container body 11. Then, the cover plate 21 of the heating device 20 covers the container body 11 of the inner pot assembly 10 with the insertion hole 42 of the coupler 40 being inserted by the driven shaft 13. After the heating device 20 is powered, the electric heating tube 24 rises its temperature to generate hot air, and the impeller 23 rotates to blow the hot air toward the food items. The rotation of the driving spindle 221 of the motor 22 drives the driven shaft 13 to rotate accordingly. The rotating speed of the driven shaft 13 is reduced by the gears of the speed-reducing mechanism 14, thereby making the rotatable sleeve 12 to drive the stirring member 15 and its blades 152 to rotate at a lower speed. Each of the blades 152 stirs the food items slowly, so that the food items received in the cylinder 111 can be heated and baked uniformly.

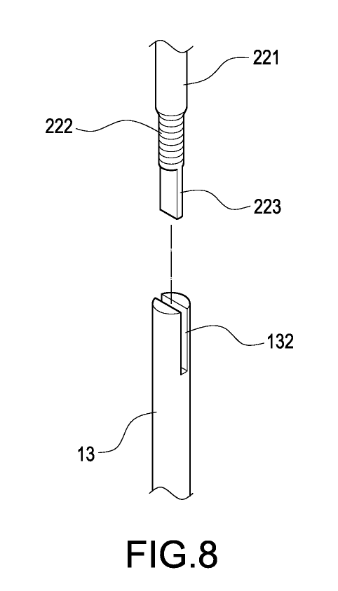

Please refer to FIG. 8, which shows another embodiment of the driving spindle 221 and the driven shaft 13 of the present invention. The free end of the driven shaft 13 protrudes from the stirring member 15 (this case is not shown) or is in flush with the top surface of the central base 151 of the stirring member 15 (this case is not shown). The free end of the driven shaft 13 is provided with an insertion slot 132. Further, the front end of the driving spindle 221 of the motor 22 extends to form an inserting plate 223, which is inserted into the insertion slot 132. With this arrangement, the same effect as that of the aforesaid coupler 40 can be achieved. Alternatively, the free end of the driven shaft 13 protrudes outside the stirring member 15 (not shown) and is provided with an insertion slot 132.

According to the above, the inner pot assembly for a hot-air baking oven and a hot-air baking oven having such an assembly according to the present invention really demonstrates industrial applicability, novelty and inventive steps. Further, the structure of the present invention has not been seen in product of the same kind or let in public use. Thus, the present invention conforms to the requirements for a utility model patent.

What is claimed is:

1. An inner pot assembly for a hot-air baking oven, comprising:
a container body with its bottom having a shaft mount;
a rotatable sleeve penetrating the shaft mount to be rotatable with respect to the shaft mount;
a driven shaft penetrating the rotatable sleeve to be rotatable with respect to the rotatable sleeve;
a speed-reducing mechanism fixed to the container body, the speed-reducing mechanism having a speed-reducing gear set driven by the driven shaft and driving the rotatable sleeve to rotate; and
a stirring member connected to the rotatable sleeve and received in the container body, the stirring member being driven by the rotatable sleeve.

2. The inner pot assembly for a hot-air baking oven according to claim 1, wherein the container body comprises a cylinder having a closed end and a base plate fixed to the cylinder, the shaft mount is formed on the base plate.

3. The inner pot assembly for a hot-air baking oven according to claim 2, wherein a bottom of the cylinder protrudes to form a hollow post, the hollow post allows the rotatable sleeve to penetrate therethrough and is located to face the shaft mount.

4. The inner pot assembly for a hot-air baking oven according to claim 2, wherein the speed-reducing mechanism further comprising a casing for sealing the base plate and receiving the speed-reducing gear set.

5. The inner pot assembly for a hot-air baking oven according to claim 1, wherein a free end of the driven shaft protrudes outside the stirring member and is formed with a positioning plane.

6. The inner pot assembly for a hot-air baking oven according to claim 1, wherein a free end of the driven shaft protrudes outside the stirring member and is provided with an insertion slot.

7. An inner pot assembly for a hot-air baking oven, comprising:
a container body with its bottom having a shaft mount;
a rotatable mechanism penetrating the shaft mount to be rotatable with respect to the shaft mount;
a speed-reducing mechanism fixed to the container body, the speed-reducing mechanism having a speed-reducing gear set in mutual transmission with the rotatable mechanism; and
a stirring member connected to the rotatable mechanism and received in the container body, the stirring member being driven by the rotatable mechanism.

8. The inner pot assembly for a hot-air baking oven according to claim 7, wherein the container body comprises a cylinder having a closed end and a base plate fixed to the cylinder, the shaft mount is formed on the base plate.

9. The inner pot assembly for a hot-air baking oven according to claim 8, wherein a bottom of the cylinder protrudes to form a hollow post, the hollow post allows the rotatable mechanism to penetrate therethrough and is located to face the shaft mount.

10. The inner pot assembly for a hot-air baking oven according to claim 7, wherein the speed-reducing mechanism further comprising a casing for sealing the base plate and receiving the speed-reducing gear set.

11. The inner pot assembly for a hot-air baking oven according to claim 7, wherein the rotatable mechanism comprises a driven shaft, a free end of the driven shaft protrudes outside the stirring member and is formed with a positioning plane.

12. The inner pot assembly for a hot-air baking oven according to claim 7, wherein the rotatable mechanism comprises a driven shaft, a free end of the driven shaft protrudes outside the stirring member and is formed with an insertion slot.

13. A hot-air baking oven having an inner pot assembly, comprising:
an outer pot having a chamber therein;
a heating device has a cover plate covering the outer pot and a motor mounted over the cover plate, the motor having a driving spindle; and
an inner pot assembly received in the chamber and including:
a container body with its bottom having a shaft mount;
a rotatable sleeve penetrating the shaft mount to be rotatable with respect to the shaft mount;
a driven shaft penetrating the rotatable sleeve to be rotatable with respect to the rotatable sleeve;
a speed-reducing mechanism fixed to the container body, the speed-reducing mechanism having a speed-reducing gear set driven by the driven shaft and driving the rotatable sleeve to rotate; and
a stirring member connected to the rotatable sleeve and received in the container body, the stirring member being driven by the rotatable sleeve.

14. The hot-air baking oven having an inner pot assembly according to claim 13, wherein the container body comprises a cylinder having a closed end and a base plate fixed to the cylinder, the shaft mount is formed on the base plate.

15. The hot-air baking oven having an inner pot assembly according to claim 14, wherein a bottom of the cylinder is formed with a hollow post, the hollow post allows the rotatable sleeve to penetrate therethrough and is located to face the shaft mount.

16. The hot-air baking oven having an inner pot assembly according to claim 14, wherein the speed-reducing mechanism further comprising a casing for sealing the base plate and receiving the speed-reducing gear set.

17. The hot-air baking oven having an inner pot assembly according to claim 13, further comprising a coupler, one end of the coupler being provided with an inner thread, a distal end of the driving spindle extending to form an outer thread for threadedly connecting with the inner thread.

18. The hot-air baking oven having an inner pot assembly according to claim 17, wherein a free end of the driven shaft protrudes outside the stirring member and is formed with a positioning plane, the other end of the coupler is provided with an insertion hole, an inner wall of the insertion hole is formed with a restricting plane for mating with the positioning plane.

19. The hot-air baking oven having an inner pot assembly according to claim 13, wherein a free end of the driven shaft is provided with an insertion slot, a front end of the driving spindle of the motor extends to form an inserting plate, the inserting plate is inserted into the insertion slot.

20. The hot-air baking oven having an inner pot assembly according to claim 13, wherein a free end of the driven shaft protrudes outside the stirring member and is provided with an insertion slot, a front end of the driving spindle of the motor extends to form an inserting plate, the inserting plate is inserted into the insertion slot.
